(19) United States
(12) Patent Application Publication
(10) Pub. No.: US 2015/0102192 A1
(43) Pub. Date: Apr. 16, 2015

(54) PORTABLE SUSPENSION DEVICE FOR GYM ACCESSORIES

(71) Applicant: Julie Ann Ciampi, Branford, CT (US)

(72) Inventor: Julie Ann Ciampi, Branford, CT (US)

(21) Appl. No.: 14/050,519

(22) Filed: Oct. 10, 2013

(51) Int. Cl. A63B 71/00; F16B 2/00; F16M 13/02; F16B 45/00

(52) U.S. Cl. CPC A63B 71/00; F16B 45/00; F16B 2/00; F16M 13/02
USPC 248/309.4; 248/339

(57) ABSTRACT

A portable suspension device for workout accessories comprising a backing, where the backing includes a front face and a back face; a hook attached to the front face of the backing, where the hook is attached to the backing with a fastener; a magnet on the back face, where the magnet enables the portable suspension device to attach to a piece of exercise equipment; and at least one exercise accessory to hang off the hook. The portable suspension device enables a user to attach the hook to the exercise equipment and then hang their accessories while they workout to prevent the accessories from touching the ground.

### BACKGROUND OF THE INVENTION

1. Field of the Invention

The present invention relates to a device that attaches to one or more pieces of gym equipment to hang a user's gym accessories while working out.

2. Description of Related Art

Exercise is an important part of a healthy lifestyle. It is often suggested that a person should exercise for 30 minutes at least three times a week. Gyms are popular places for people to work out. Most gyms offer multiple types of exercise equipment including cardio machines, free weights, weight machines and weight racks. With all these pieces the user is able to get a complete workout, and reach the recommended weekly regimen.

While at the gym, most exercisers carry many personal items like a water bottle, towel, keys and/or a music player to each exercise machine they plan to use. This may become tedious carrying all of these individual items every time they transition between the different machines.

Also, the machines typically do not have a storage place where the person can place all of their things, so they are forced to place them on the floor. The floors are often dirty from all the people perspiring and tracking moisture throughout the gym. This moisture and sweat may collect dirt and breed bacteria which soil the user's items. Also, after just a few people leave their items on the floor, the gym will appear cluttered and messy. This is a potential hazard to other gym goers, due to risk of tripping or the items getting caught in the nearby machines.

Therefore, it would be beneficial in the art to provide a device that keeps a user's personal items off the floor in order to keep the items cleans. It would also be desirable in the art to provide a device that is portable so that the user can transfer the device with them as they move from machine to machine.

### SUMMARY OF THE INVENTION

In view of the foregoing disadvantages inherent in the prior art, the general purpose of the present invention is to provide a portable suspension device to hang gym accessories, configured to include all of the advantages of the prior art, and to overcome the drawbacks inherent therein.

Accordingly, an object of the present invention is to provide a suspension device that attaches to a piece of gym equipment to enable a user to hang their personal belongings on the device while they workout.

Another object of the present invention is to provide a suspension device that includes a retractable hook so that the device is easily stored in a bag or locker when not in use.

To achieve the above objects, in an aspect of the present invention, a portable suspension device is described comprising a backing, where the backing includes a front face and a back face; a hook attached to the front face of the backing, where the hook is attached to the backing with a fastener; a magnet on the back face, where the magnet enables the portable suspension device to attach to a piece of exercise equipment; and at least one exercise accessory to hang off the hook. The portable suspension device enables a user to attach the hook to the exercise equipment and then hang their accessories while they workout to prevent the accessories from touching the ground.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a front view of a portable suspension device for gym accessories in accordance with an exemplary embodiment of the present invention;

FIG. 2 depicts a backside view of a portable suspension device for gym accessories in accordance with an exemplary embodiment of the present invention; and

FIG. 3 depicts a perspective view of a gym bag in accordance with an exemplary embodiment of the present invention.

Like reference numerals refer to like parts throughout the description of several views of the drawings.

### DETAILED DESCRIPTION OF THE DRAWINGS

The present invention relates to a device that attaches to one or more pieces of gym equipment to hang a user's gym accessories while working out. The present invention provides a portable suspension device to hang a user's personal belongings while using exercise machines. The portable suspension device is attached to the exercise machines with a strong magnet to allow it to be easily removed as the user transitions from one machine to the next. A hook extends from the front of the portable suspension device to enable the user to hang their gym bag, towel, water bottle, music player, keys or other accessories. By using the portable suspension device the user is able to keep their items off the dirty floor and prevent cluttering the workspace around them.

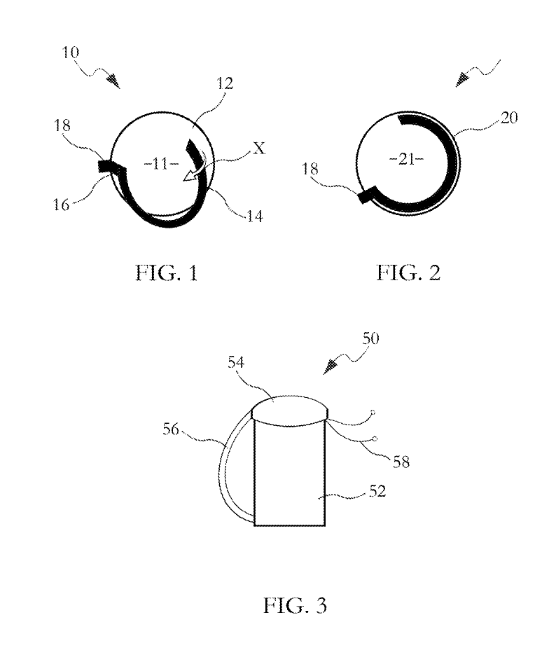

Turning now descriptively to the drawings, referring to FIG. 1, a front view of a portable suspension device 10 is shown in accordance with an exemplary embodiment of the present invention. The portable suspension device 10 may comprise a backing 12 where the backing 12 is shaped as a circle, rectangle or other geometrical shape. The backing 12 includes a front face 11 upon which a logo, picture or symbol may be placed. The backing 12 may be made from a thick plastic, glass, ceramic, metallic or similar material. The material must be able to withstand repeated handling, and potential dropping since the nature of its use is in a rugged environment.

Attached to an edge of the backing 12 may be a hook 14. The hook 14 is attached at a spring-loaded fastener 16. The fastener 16 is coupled with a button 18 that when pressed extends the hook 14 from the front face 11. When the portable suspension device 10 is not in use the hook 14 may lock in a rest position (as shown) against the front face 11. In the rest position the portable suspension device 10 is more easily storable, so the user may place it in their bag or locker when not in use. When the user presses the button 18 the hook 14 extends in the direction of arrow X perpendicularly from the backing 12 into a hooking position. The spring-loaded fastener 16 is strong enough to support the hook 14 while heavy objects, like a gym bag is suspended from it.

Referring now to FIG. 2, a backside view of the portable suspension device 10 is shown in accordance with an exemplary embodiment of the present invention. The backing 12 includes a back face 21. On the back face 21 is a magnet 20. The magnet 20 may be centrally positioned taking over the entire back face 21. Alternatively the magnet 20 may encompass the peripheral edge of the back face 21 (as shown). The magnet 20 is strong enough so that during use when objects are hung from the hook 14 the portable suspension device 10 remains in position on a piece of exercise equipment. The exercise equipment may be items like an exercise machine, a weight rack, bench rack or the like.

Referring to FIG. 3, a perspective view of a gym bag 50 is shown in accordance with an exemplary embodiment of the present invention. The gym bag 50 includes a housing 52 within which the user places their personal belongings. At a top portion of the housing 52 may be a flap 54 which covers an opening into the housing 52. The housing 52 includes a shoulder strap 56 from which the user may hang the gym bag 50 on the hook 14 of the portable suspension device 10. The top portion of the housing 52 includes a drawstring 58 which cinches the opening to prevent the enclosed items from falling out. With the portable suspension device 10 the user does not have to place their gym bag 50 on the floor exposing it to dirt and bacteria. Also, by keeping the gym bag 50 suspended from the workout machines the gym floors remain uncluttered so that others do not trip while working out, thereby providing a safer workout environment for everyone involved.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A portable suspension device for workout accessories comprising:
a. a backing, where the backing includes a front face and a back face;
b. a hook attached to the front face of the backing, where the hook is attached to the backing with a fastener;
c. a magnet on the back face, where the magnet enables the portable suspension device to attach to a piece of exercise equipment; and
d. at least one exercise accessory to hang off the hook.

2. The portable suspension device according to claim 1, where the fastener is spring-loaded.

3. The portable suspension device according to claim 2, where the fastener includes a button to release the hook from a rest position against the front face to a hooking position perpendicular from the backing

4. The portable suspension device according to claim 1, where the magnet wraps around a peripheral portion of the back face of the backing.

5. The portable suspension device according to claim 1, where the magnet is centrally positioned on the back face of the backing.

6. The portable suspension device according to claim 1, where the hook supports a gym bag, where the gym bag receives the exercise accessories.
